(19) United States
(12) Patent Application Publication
(10) Pub. No.: US 2026/0341172 A1
(43) Pub. Date: Oct. 29, 2026

(54) VIRTUAL CLASS

(71) Applicant: NEXT OPUS VENTURES LLP, Singapore (SG)

(72) Inventors: Carlos Nicholas FERNANDES, Singapore (SG); Varsha JAGDALE, Singapore (SG); Chamonix FERNANDES, Singapore (SG); Leon Neil FERNANDES, Singapore (SG)

(21) Appl. No.: 19/104,908

(22) PCT Filed: Aug. 18, 2023
(86) PCT No.: PCT/SG2023/050570

§ 371 Date: Feb. 19, 2025

(30) Foreign Application Priority Data
Aug. 19, 2022 (SG) 10202250782R
Apr. 17, 2023 (SG) 10202301058U

(51) Int. Cl. G09B 7/02; G06F 3/14; G06F 40/40; G06T 13/40

(52) U.S. Cl. CPC G09B 7/02; G06F 3/1454; G06F 40/40; G06T 13/40

(57) ABSTRACT

Disclosed is a method of creating an interactive class. The method involves processing content of a class to identify one or more topics covered by the content and a timestamp corresponding to each said topic, and then processing each topic to produce a learning intervention corresponding to the topic. The method then involves creating the interactive class by embedding each learning intervention at the corresponding timestamp in the class, the class being configured such that on a user progressing through the interactive class to a first said timestamp the interactive class is paused for display of the learning intervention corresponding to the first timestamp.

### TECHNICAL FIELD

The present invention relates, in general terms, to a virtual class. More particularly, the present invention relates to, but is not limited to, creating classes, playing virtual classes to students and responding to student queries.

### BACKGROUND

Short of the expensive proposition of building new or expanding old facilities, the conventional classroom based institution is not to be expanded rapidly enough to meet the educational demands of our burgeoning information age. Even if classroom space was available, the lack of qualified instructors would greatly limit the opportunity for students to be instructed in various courses of study.

A fortuitous combination of technology used to provide information in a nearly real-time time frame, coupled with the communications industry, has allowed the creation of remote learning capabilities in which a teacher is at a remote location with respect to the students. However, no commercial system available today is capable of combining the synchronous capabilities of live remote classes with the efficiency and scalability of pre-recorded video. In addition, the existing remote learning capabilities cannot fulfil the needs of different students from different backgrounds and different levels of comprehension of a particular topic, to study the same course and to absorb information based on their capability.

It would be desirable to overcome all or at least one of the above-described problems.

### SUMMARY

Disclosed herein is a method of creating an interactive class, comprising:
processing content of a class to identify one or more topics covered by the content and a timestamp corresponding to each said topic; processing each topic to produce a learning intervention corresponding to the topic; and
creating the interactive class by embedding each learning intervention at the corresponding timestamp in the class, the interactive class being configured such on progressing through the interactive class (i.e. the user progressing through the interactive class) to a first said timestamp the interactive class is paused for display of the learning intervention corresponding to the first timestamp.

The “class” will, in general, be a “virtual class” (i.e. a pre-recorded class played back to a student, or a class conducted at a location remote from the student and attended by the student through electronic means such as ZOOM.

Also disclosed is a method of creating a virtual class (i.e. an interactive class) based on a plurality of videos, comprising:
synchronising display of a first video of the plurality of videos to a plurality of viewers;
identifying one or more timestamps in the first video;
synchronizing display of one or more learning interventions related to the first video to the viewers at each of the one or more timestamps;
collecting a response from each viewer to the one or more learning interventions; and
for each viewer, selecting one or more respective videos from the plurality of videos to display to the viewer based on the response of the viewer.

The method for creating a virtual class may be performed on a class generating using the above method for creating a class.

Also disclosed is a system for creating a class, comprising a memory and at least one processor configured to:
process content of a class to identify one or more topics covered by the content and a timestamp corresponding to each said topic;
process each topic to produce a learning intervention corresponding to the topic; and
create the interactive class by embedding each learning intervention at the corresponding timestamp in the video, the class being configured such that on a user progressing through the interactive class to a first said timestamp, and the interactive class is paused for display of the learning intervention corresponding to the first timestamp.

In some embodiments, the one or more learning interventions comprise one or more of an open-ended question, a multiple choice question, an audio-based intervention, an video-based intervention, and a 3D virtual intervention.

In some embodiments, synchronizing display of the first video to the viewers comprises tracking playback for the first video for each viewer.

In some embodiments, displaying the learning interventions to the viewers comprises synchronizing the learning interventions for the viewers, based on a network latency for each viewer.

In some embodiments, for each viewer, selecting one or more respective videos from the plurality of videos to display to the viewer based on the response of the viewer comprises verifying the response of the viewer against one or more conditions.

In some embodiments, verifying the response of the viewer comprises checking if the response corresponds to an entry in a database.

In some embodiments, the method comprises streaming the viewers to a plurality of groups based on the response and/or behaviour of each viewer.

In some embodiments, the method comprises annotating the videos using a natural language processing (NLP) approach.

In some embodiments, annotating the videos comprises, each video, using NLP to:
analyse content of the video; and
formulate one of the one or more interventions based on the content.

Disclosed herein is also a system for creating a virtual class based on a plurality of videos, comprising a plurality of processors configured to:
synchronise display of a first video of the plurality of videos to a plurality of viewers;
identify one or more timestamps in the first video;
synchronise display of one or more learning interventions related to the first video to the viewers at each of the one or more timestamps;
collect a response from each viewer the one or more learning interventions; and
for each viewer, select one or more respective videos from the plurality of videos to display to the viewer based on the response of the viewer.

### BRIEF DESCRIPTION OF THE DRAWINGS

Embodiments of the present invention will now be described, by way of non-limiting example, with reference to the drawings in which:

FIG. 1 is the front view of an example method of creating a virtual class;

FIG. 2 is a schematic diagram showing components of an exemplary computer system for performing the methods described herein; and

FIG. 3 illustrates a method for creating or generating a class.

### DETAILED DESCRIPTION

The present invention relates to a method of creating a virtual class based on a plurality of videos, articles, audio books, audio articles or a combination thereof. For each student or viewer (the terms “student”, “viewer”, “participant” and similar—the term “user” may also be applied unless context dictates that term is applied to a teacher, lesson creator or similar), the plurality of videos may together form a longer video, or may branch into other videos each of which may also be from a different longer video. In this sense, a longer video comprises a plurality of smaller videos or video segments.

It will be appreciated that a student can also take a pre-recorded class and run it for a set of friends at a specific time. So, instead of a traditional class where all students are in the session, a student can just choose their friends and can choose to study with their friends by attending the class in a synchronised manner without any teacher involvement or event awareness.

The present disclosure relates to platforms for creating classes, synchronous videos and learning interventions for real-time participant interactions, including interactions between participants, and feedback. More specifically, methods and systems as disclosed herein create a class, create learning interventions based on content of a class, provide a virtual class where teachers and students may have an improved learning experience, including one-on-one interactions and multimedia access, and can automatically generate feedback. In general, the present invention enables a live class through synchronizing a sequence of videos and learning interventions.

From a pedagogical perspective, it is well established that teachers are critical in helping students learn. As the Internet has caused digital disruption, a theory began to emerge. That is, if good teachers are so essential, the best teachers could be pre-recorded while teaching a topic and students could then play back the recording at any time, at their convenience, thereby massively scaling education. This idea, while theoretically persuasive, has not lived up to its anticipated potential. This breaks down due to differences between a video recording of an instructor teaching a class (or speaking into a camera) compared with a sitting in a class and listening to the instructor. In fact, the irony is that more and more instructors playback educational videos in classrooms because educational videos can sometimes richly explain difficult concepts through animations and other mechanisms.

The key reasons behind this are three-fold. First, videos are “one-way” communication. In a real classroom setting, a teacher might start off an explanation by asking students a question or a teacher might interrupt her session, to a raised hand. In fact, a teacher might interrupt her own explanation midway by asking students questions to see if her students are still catching on.

Second, the ability to watch a video “anytime” in the comfort of a viewer's home alone can actually be a “bug” and not a feature. Most learners (particularly young ones) are incapable of self-regulated learning. It's easy to doze off or lose focus while watching a video—it's easy to put off watching a video for later.

Videos that can be watched “anytime” are sometimes never watched. There is an element of peer-motivation, when an entire class is congregating together to learn something. Just like a movie theatre experience with friends and family is different from watching the same movie on a viewer's mobile phone, a classroom experience is very different from a solitary video watching experience from the perspective of peer presence and participation.

Third, video is not an immersive classroom experience. A classroom experience is immersive because students are in the same class. It will be appreciated that live classes (i.e. classes taught in real time by teachers located remotely from students) are not very different from real classroom experiences in this sense except for the immersive aspect of being physically in the same classroom.

In relation to videos becoming interactive, methods described herein provide a teacher/instructor the ability to not just embed questions, quizzes, and audio notes into a class (e.g. video), but also to embed videos into a video. Such design allows an instructor to plan, “pre-program” and pre-record an entire virtual class. For example, an instructor can predetermine the videos to play, the sequence in which videos (which can be third party videos found on the Internet or the instructor's own videos) will play, the quizzes that will appear and when they will be presented, and the video interventions overlaid on top of the primary video list (for example, on top of a third party video to add more context). Once this pre-programming is done—the created “live-like” pre-programmed virtual class can be shared for students to attend. This pre-programmed virtual class can be scheduled and played synchronously for many students where students answer questions simultaneously. In some scenarios, the students can see each other's answers. The students' answers may also be watched asynchronously.

Notably, the examples described below will be mainly given with respect to videos. However, the same concepts can be applied to articles, audio books and similar. For example, a user may progress through an article or audio book—i.e. read to a certain point in the article or listen up to a certain point in the audio book, rather than watch through a video—and then receive a learning intervention in the form of text or video for an article, or audio for an audio book. The “certain point” is therefore a timestamp in the article or audio book, where a timestamp in an article may not relate specifically to “time” but instead to a location in the article. Correspondingly, a topic in an article may complete at the end of a paragraph and, in an audio book, may complete when a speaker ends discussion on a particular topic.

Delivering a pre-programmed virtual class with videos, learning flows, quizzes, interventions etc. minimises and possibly eliminates the need for a teacher/instructor each time the “virtual class” is aired. In some embodiments, a hybrid pre-programmed virtual class may be interrupted by live involvement from a teacher or instructor (the two terms being used interchangeably unless context dictates otherwise). This can be done when a particular event (for example, too many students getting an answer wrong) triggers a notification being sent to an instructor who can interrupt the virtual class and take over. In another embodiment, a teacher/instructor can join the first 5 minutes of a virtual class, launch it live and then leave the room, thereby significantly increasing the number of students he/she can teach and the number of classes that they can simultaneously run.

In some embodiments, the present invention relates to a virtual class or learning system providing interactivity between a teacher and multiple students, where one or more, and preferably all, students are remotely located with respect to the teacher. In some embodiments, the content (i.e. the video) may play on a common or single screen in a classroom but each viewer has a terminal or device with the learning interventions (such as quizzes) being displayed and responded to on the viewers' device. In some cases, results of responses to learning interventions are displayed on the common screen for everyone in the class to see. As will be discussed in detail, the teacher can jump in when notified to handle exceptions. For example, if there is a learning intervention that requires knowledge from the students, and say 60% of the students get the wrong answer, the teacher can receive a notification and pause the virtual class and take control of the class through a live video conference. Said in-class experience can also include scores of all students visible to the teacher. For example, if a student is not looking at the screen or is distracted, but is answering learning interventions correctly, it may indicate that the student is “advanced”. Eye tracking technology can also be employed in checking each student's status or concentration level. For example, eye tracking may be used to assess a viewer's level of concentration, attention or focus, and then stream the student into a more complex class (if the student's responses to learning interventions are accurate, despite the student having a low level of attention), grab the student's attention (e.g. increasing volume of the video or intervention, or playing an alarm, if the student has a low attention level) or stream the student into a less complex class (if the student is not paying attention because they do not understand the content, as reflected in their attention level and inaccurate or non-existent responses to learning interventions). It will be appreciated that the in-class experience or playback of the virtual class involves a personal display (i.e. intervention screen) for students to answer “interactive” interventions.

In other embodiments, the virtual class is created in advance, the interactive class is then provided by the learning system to the multiple students. In such a case, the virtual class may be pre-configured, that is, the teacher/instructor may not be involved in the virtual class. This virtual class is designed to allow remote students at any location to synchronously attend a live class, participate during the class, and create and submit class work assignments for teacher review—the class work and assignments may be responses to learning interventions, where such a learning intervention is a request for a comprehensive answer to a particular query or particular queries. The virtual class provides a conduit for connectivity, overcoming the barriers of geographic location and physical limitations of brick and mortar institutions, thereby bringing the student and the teacher into a learning space without physical barriers. The virtual class is a tool to extend the reach of class instruction to students who would otherwise be unable to attend classes.

It will be appreciated that in the present disclosure, based on each student's response to the learning interventions (e.g. work assignments or answers to a quiz), the system can display different videos to different students to enhance the learning experience. It is hence possible for a teacher to start with an identical video for multiple students, and develop learning pathways for different students based on the students' responses to the learning interventions. This means that when a student struggles to answer certain questions, the video delivered to this student can immediately become “easier” by delivering more foundational content. Similarly the video can get more “difficult”, for students that respond to interventions easily. For any student, the ease of answering may be determined by one or more of the time taken to answer, the accuracy of the answer, where a different answer was selected before a final answer was given and other measures. As such, a class of multiple students can be auto-streamed into separate groups based on their performance, without them even knowing that they have been auto-streamed. Such design combines both community interaction as well as highly targeted classes.

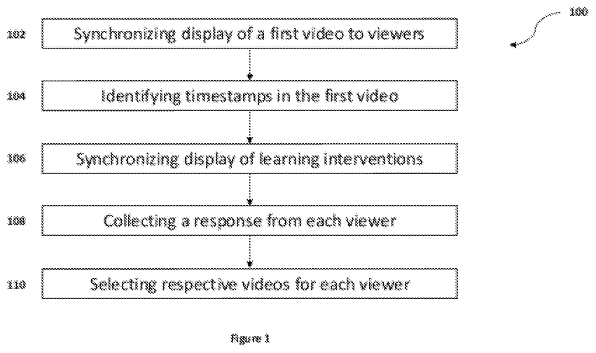

FIG. 1 illustrates a method 100 of creating a virtual class based on a plurality of videos. As mentioned before, the virtual class refers to an interactive teaching system in which a teacher is located at a location remote from the viewers (i.e., students). The method 100 broadly comprises:
step 102: synchronising display of a first video of the plurality of videos to a plurality of viewers;
step 104: identifying one or more timestamps in the first video;
step 106: synchronizing display of one or more learning interventions related to the first video to the viewers at each of the one or more timestamps;
step 108: collecting a response from each viewer to the one or more learning interventions; and
step 110: for each viewer, selecting one or more respective videos from the plurality of videos to display to the viewer based on the response of the viewer.

The virtual class, including the video or videos and one or more learning interventions, may be pre-recorded or otherwise predetermined. In its broadest sense, the method 100 may involve synchronising a video (step 102), at a particular identified timestamp (step 104), synchronizing display of a learning intervention (step 106—e.g. question or an embedded video), collecting a response (step 108—which may involve simply awaiting completion of display of the intervention on all devices to enable step 110 to take place synchronously) and continuing with display of the video (step 110). In this circumstance, the video selected at step 110 is the original video and may be the same for all users.

In some embodiments, the virtual class includes, at the teacher's location, an instructional workstation for the presentation of educational materials and a student interactivity monitor/control workstation, as well as a plurality of student workstations at a remote location. Although it is possible that several of the student workstations can all be located in a single central area remote from the teacher's workstation, in a preferred embodiment each of the students' workstations are not only remote with respect to the teacher's location, but are also remote with respect to each other's workstation.

Present methods are directed at instructing students at a remote location, this can be accompanied by the teacher's presentation made to students in the teacher's class, as well as presenting educational materials to students located at remote terminals. In some examples, the educational materials are a plurality of recorded videos. There are two types of recorded videos that can be added—embedded videos from third parties, as well as the teacher's own videos that the teacher can record and upload. For example, the teachers can first find a video on YouTube, upload their own videos or reuse video lessons created by others. The teachers can further edit the video, for example by recording their voice to personalize it, and hold the students accountable by embedding learning interventions in the video. The teachers are then allowed to synchronise display of the videos to the students and check their progress in real-time. In some embodiments, synchronizing the videos for the viewers comprises tracking playback for the first video for each viewer, and synchronising the first video for each viewer based on differences in time of reaching a particular point (e.g. due to differing network latency for individual viewers) or timestamp in the video during playback.

The present methods also allow a live presentation of the teacher's lesson to students situated at a remote location. In such cases, the videos presented to the students are related to a live presentation of the teacher's lesson to students situated at a remote location. One or more cameras may be directed at the teacher, allowing the presentation to be properly transmitted. Since the instructional computer desktop display is also transmitted to each of the remote students, a camera is directed at the teacher's physical desktop, allowing the transmission of objects displayed to the camera by the teacher. The teacher's workstation could also include other instructional aids, such as a blackboard. Therefore, one or more of the cameras could also be directed at the blackboard. The system may also comprise an electronic board (e.g. electronic whiteboard or blackboard) where the work product of the teacher on the electronic board is reproduced on a portion of the display of one or more of the students (e.g. may be displayed to a student or students who asked a particular question or similar questions). It will be appreciated that each of the cameras would be operated by a technician or would be rotated under the control of the teacher to insure that the cameras are pointed in the proper direction.

In some embodiments, the teacher's workstation would also include a video monitor upon which would be viewed each of the students interactivity with respect to various learning interventions posed by the teacher in the teacher's presentation. The teacher's workstation would also allow the teacher to select different optional configurations for student interactivity. In the present disclosure, the proposed method comprises streaming the viewers to a plurality of groups based on the response and/or behaviour of each viewer. For example, the system for performing the method 100 can decide how the videos flow and the various learning paths according to the learning intervention. For example, teachers can choose to review the virtual classes in real-time and remove students from the classroom for one-on-one (or smaller group) coaching, or simply route them to more appropriate videos that match their capability. In one embodiment, if there is a learning intervention that requires knowledge from the students, and say a particular student gets the wrong answer, the teacher can receive a notification and remove this particular viewer from the virtual class for one-on-one coaching and take control of the coaching through a live video conference.

Each of the students' workstations would include a respective monitor, as well as respective personal computers. Each of the student workstations would include input means, such as respective keyboards, as well as respective mouse input. A particular student workstation will be described in more detail herein below. All of the student workstations may be at a central location, or may be remote from the teacher's workstation. More preferably, each of the students' workstations would be remote, not only the teacher's workstation, but also each of the other students' workstations. Each student's monitor can be provided with a camera or other video device to allow the teacher to view each respective student on the teacher's monitor. Microphones may be associated with one of the student's monitors to allow each student to provide an audio input transmitted to the teacher's speaker or to the class as a whole (i.e. the teacher and all students), or to part of the class (e.g. the teacher and all students undertaking the same stream-e.g. easy/simple or hard/complex).

Each of the students' workstations may include a status line section giving positive confirmation that a student's response has been received by the teacher. Furthermore, an answer box (e.g. a free-text input field) would be provided on each student's video monitor allowing the student to type a response to the learning interventions sent from the teacher, as well as input a question or comment and send this question or comment to the teacher. Each of the students' monitors and/or keyboards would include a variety of buttons or icons to allow the student to respond to and interact with the teacher. Typical responses might include a ‘yes’ or ‘no’ answer, a multiple choice quiz response, or a raised hand indicator. Said responses could trigger an alert, where questions generated by the students can then be collected. The teacher may address different queries raised by different students together later in the virtual class. Each of the students' workstations may include a camera and appropriate video capture hardware and software to allow a real time image of the students to be transmitted to the teacher's monitor/control workstation upon selection by the teacher. This image would also be capable of retransmission to all of the connected students at the discretion of the teacher.

In the present disclosure, communication between the teacher's workstation and each of the students' workstations would be accomplished in any known communication means, such as utilizing the Internet, employing a standard telephone line or a dedicated line, or any other type of communication such as wireless communication. Although it is contemplated that there would be no direct communication between different students' workstations, it is conceivable that such a connection would be utilized, particularly if this communication utilized the teacher's workstation as an intermediary.

At step 102, a pre-recorded first video of the plurality of videos is synchronously displayed to all the students. In particular, the teacher can track the video playback on each user's system and make sure that all students are seeing the same thing at the same time. The video playback on each user's system may be automatically tracked, for example by the teacher's workstation. In some embodiments, the synchronization of the first video is accomplished by tracking the location of the scroll bar. It will be appreciated that the first video is identical for the students. In some examples, the first video is a brief introduction of the course.

As will be discussed later, at steps 106 and 108, one or more learning interventions related to the first video will be used to test the students' understanding of the course. Such design allows the teacher to develop learning pathways for different students based on responses the students give to the learning interventions. This solves an important problem. That is, different students may need different study materials to study and complete a course. For example, if the course relates to the concept of a “catalyst”, a 9-th grader won't need an explanation of the term “catalyst”, and an explanation of the term will make the 9-th grader loose interest about the course. On the other hand, since a 5-th grader would not know the meaning of the word “catalyst”, he or she can “get by” (i.e. understand generally what is happening) without knowing the meaning of the term, but wouldn't get all they can from a learning perspective. In such case, the educational value is limited because younger watchers of the video will broadly understand the course the teacher is presenting, but won't actually be able to learn from it.

The proposed method 100 may comprise capturing the first video from an original video according to the content of the learning interventions. In one embodiment, the original video records a machine learning algorithms course, which also includes probability theory as the fundamental course. For those students who have already learnt probability theory, they would wish to skip this fundamental course. However, those students who do not understand probability theory will find the machine learning algorithms course hard to understand. In such cases, to develop learning pathways for different students, a learning intervention testing the student's understanding of probability theory can be included. Accordingly, the first video captured from the original video will include video segments, before probability theory is taught, based on the responses of the added learning intervention. In some examples, the learning intervention will be added right after the first video is played. In another practical application, a machine learning video may be displayed with a brief comment on probability theory. A learning intervention on probability theory is then displayed and, based on the answers of each student, the students are then either displayed the next video on machine learning (if they answer accurately to the intervention) or a video on probability theory (if they answer inaccurately to the intervention). After undertaking any review video—e.g. video on probability theory—the students may then be displayed the main video —i.e. the video on machine learning. In this sense, the students can be streamed based on their comprehension of particular subject matter, while ensuring all students cover at least the material of the first video from its start to its completion.

It will be appreciated that the videos used for creating the virtual class can be annotated by using a natural language processing (NLP) approach, which is a subfield of linguistics, computer science, and artificial intelligence concerned with the interactions between computers and human language, in particular how to program computers to process and analyse large amounts of natural language data. NLP combines computational linguistics—rule-based modelling of human language—with statistical, machine learning, and deep learning models. Together, these technologies enable computers to process human language in the form of videos and to ‘understand’ its full meaning, complete with the speaker or writer's intent and sentiment. In the present disclosure, annotating the videos comprises, for each video, using NLP to analyse content of the video by processing the human language appearing in the videos and formulating one of the one or more interventions based on the content.

The system can then, according to the students' responses to the learning intervention, decide which students would need to learn probability theory, and which students can simply skip the fundamental course so as to improve the learning experience. The proposed system may further stream the viewers to a plurality of groups based on the response of each viewer-i.e. automatic streaming. Streaming can be done based on various factors or behaviours of a viewer including the speed of response of each viewer, the accuracy of the response or overall accuracy of responses of each respective viewer to a plurality of learning interventions or questions. Streaming here means segmentation or separation of students, i.e., students are streamed into different classes based on performance. It will be appreciated that such design combines both community and highly targeted classes.

In addition, streaming may be performed on a class level. For example, where behaviours or responses of an entire class, whether individually or on average, reflect very good understanding of a topic (e.g. accuracy of answers to a plurality of questions is above a predetermined threshold percentage, or speed of response is very fast, thereby indicating high familiarity with the subject matter) then the class may be streamed to a more complex virtual class. Conversely, where those behaviours or responses indicate poor understanding (e.g. low accuracy or very slow response speed), the class may be streamed to a less complex virtual class and/or allocated to a live teacher to continue the virtual class.

In the present disclosure, selecting one or more respective videos from the plurality of videos to display to the viewer based on the response of the viewer (see step 110) comprises verifying the response of the viewer against one or more conditions. In particular, the teacher (or the system) will check each student's response against the conditions, and accordingly deliver the original video containing the fundamental course to those students who don't have a good understating of the probability theory, and will present the original video excluding the fundamental course to those who already learnt it—the ongoing display of the video with and without the fundamental course may be synchronised. This avoids any student knowing whether they are better than, or worse than, their peers in respect of a particular topic. In one example, the fundamental course will not be presented to a student only if the following two conditions are both satisfied: 1) the student's response shows that the student understands the fundamental course; and 2) the student finished the response within a given time. If at least one of the above two conditions is not satisfied, the processor will decide that the student does not have a good understanding of the fundamental course, and the respective videos selected at step 110 need to include the fundamental course, whether that be by automatic selection or manual selection.

Moreover, display of the video after the learning intervention may occur after a predetermined period of time—e.g. learning intervention has been displayed for 30 seconds—or after a predetermined percentage or number of viewers has responded—e.g. 80% have responded, or 15 of 20 viewers (e.g. students) have responded. In addition, some learning interventions may not require a response, and thus ongoing synchronous display of video content may occur after a predetermined period, whether or not a response to a learning intervention is requested or is possible (a response to a learning intervention may not be required but may still be possible—e.g. an optional question). Moreover, for open-ended learning interventions—e.g. questions for which free-text answer is appropriate, such as “Name items that run on domestic mains power”, accuracy may be determined by reference to a predetermined list of answers (including spell correction of viewer answers where appropriate), or may be determined by comparing answers of multiple viewers and determining that answers appearing multiple times are likely to be accurate.

The processor of the proposed system is able to verify the response of the viewer by checking if the response corresponds to an entry in a database. The entry may comprise a standard answer to a learning intervention. In one example, a learning intervention is a multiple choice question, and the standard answer to this learning intervention is stored in a database. After a student answers this multiple choice question, the processor will transmit the student's answer for example via a Wi-Fi module to the database storing the standard answer. The processor will then verify the student's answer to see whether it is pre-loaded in the database and accordingly select one or more respective videos from the plurality of videos to display to the student based on the answer. In another embodiment, the answers are loaded into the memory of the computer at the time the video is loaded (or when each question is loaded), but the answers are not visible to the person. This allows a verification of an answer to occur immediately without requiring a request to the server. Verifying the response of the viewer may also comprises checking if the response corresponds to answers from other viewers. For example, if there is an open-ended question where there is no answer in the database. The answer of a specific student can be compared to other answers being submitted by other students.

In some embodiments, the virtual class is master-less (i.e. without a teacher or class coordinator present). In other words, the plurality of videos are played in an appropriate sequence, and no one can pause the video. In some other examples, the teacher (or students) has extra control to pause the class, which comprises a series of videos with learning interventions that may or may not work linearly. If a lot of students give wrong answers to a particular learning intervention, the teacher can pause the video and offer a live explanation to the students.

It will be appreciated that the learning interventions may not be only added to the end point of the first video. At step 106, one or more learning interventions need to be added (i.e. embedded) at each of the one or more timestamps in the first video (similarly, where the virtual class comprises an article or audio book, the learning intervention may comprise an embedded graphic or embedded text, for a virtual class, or an audio stream inserted into an audio book virtual class). That is to say, the teacher may need multiple learning interventions to thoroughly test a student's understanding of the course. For example, to learn the machine learning algorithms, multiple fundamental courses need to be studied in advance, such as probability theory, programming language, computer architecture, etc. During the machine learning algorithms course, the teacher will first present a brief introduction of the course in the first video, and display multiple learning interventions at different timestamps in the first video to test whether the students have taken each fundamental course. The above mentioned one or more timestamps in the first video may be identified based on the content of the learning interventions or content of the first video itself—e.g. using NLP to identify various topics presented at different times in the video, with a corresponding timestamp when the video moves to a different topic (e.g. by identifying spoken words in the video that equate to a logical paragraph in written text, and generating an intervention based on the content of the spoken words that would constitute that logical paragraph).

As mentioned, the learning interventions can be designed to be quizzes that test prior knowledge, but can also be used to test understanding of learners while the video is progressing. So for example if a concept is explained in a video as a small component of the video and not with a great deal of depth, the learning intervention can test the understanding of the concept and if the student didn't get it, it can be explained more deeply by selectively routing students to a more comprehensive video that explains that concept in depth. Besides testing, the purpose is to also keep learners engaged and attentive.

The learning interventions may be manually created, or may be determined by a machine learning model. The machine learning model may take inputs—e.g. a number of learning interventions per class (e.g. five learning interventions per class), the types of each learning intervention (e.g. one multiple choice learning intervention and two video learning interventions), the frequency of learning interventions (e.g. relative to time or amount of content, such as one learning intervention per 5 minutes or 400 words of content) and so on—and analyse content of the class to generate the learning interventions. An intervention may be generated by, for example, analysing class content using a NLP model to identify topics in the class content, conducting a search in YouTube (if a learning intervention is intended to be a video) or on Google to identify a learning intervention and then embed each learning intervention at a time stamp corresponding to conclusion of discussion of the respective topic. The conclusion can be determined by analysing the class content using NLP, to determine where topics change or the class ends, identifying the time stamp corresponding to each change and the topic being discussed immediately before the change. The learning intervention derived from the topic being discussed immediately before the change, or immediately before the class ends, is then inserted at the change of topic or end of class, respectively.

Where the learning intervention is a multiple choice question, the machine learning model may use NLP on the class content to identify a topic upon which the question should be based. It then generates a question corresponding to the topic, a correct answer (which may include searching for an answer on a search engine) and a number of incorrect answers. The incorrect answers may be checked to ensure lack of relevance to the topic. The learning intervention is then generated using the question, correct answer and incorrect answers.

To test whether absurd answers or questions are being generated by a machine learning model, the question generated by the machine learning model may be fed back to the machine learning model along with the class content, for the machine learning model to answer. The machine learning model may then also be asked to answer the question based on general knowledge—e.g. internet-based searching or a body of knowledge (taken, e.g. from Wikipedia or elsewhere on the Internet) on the topic to which the question is directed. If the answers are consistent (for multiple choice questions in particular) or have similar meanings (for open-ended questions) as determined by NLP, then the question is accepted. If the answers differ, then the question is rejected and the machine learning model generates a new question or new answer set, or both. Alternatively, when the machine learning model is asked to answer the question it has generated, if the machine learning model also outputs a confidence score, being the likelihood that the answers given by the machine learning model are sufficiently similar to consider the question and answer set acceptable, then question and answers sets with a confidence score at or above a predetermined threshold may be accepted (e.g. forwarded to a teacher for approval or manual changing), and will otherwise be rejected if the confidence score is below the threshold.

A testing system utilizing encrypted communications and accessed via a web browser may be used to provide for evaluation of students' responses to the learning interventions. Text, video, audio, graphics, and images may be used to either ask or answer questions (i.e., learning interventions). The present disclosure allows the viewers to communicate with each other during the playback of the videos and/or the learning interventions through one or more of text, video and audio. The students will be able to see each other using video and audio, and the video and audio can be automatically enabled during the time the lesson is on, but can be disabled when the learning interventions are on and vice versa. Teachers can also pre-program breaks (where the viewers can leave their desk and come back after a specified time and also entertainment videos within the viewer playlist. In some embodiments, the one or more learning interventions comprise one or more of an open-ended question, a multiple choice question, an audio-based intervention, a video-based intervention, and a 3D virtual intervention. An open-ended question is a question that is open-minded and has a “free-text” answer. An example open-ended question may be “Name a common bird in Washington”. The answers to the open-ended question can be submitted and evaluated against a pre-set list of “correct answers”, which can be determined based on answers from all students. The audio-based or video-based intervention refers to the audio/video that offers a break within the main video to add a new dimension of explanation, perhaps curated by the teacher. The break may be set to the duration of the intervention audio/video. The interventions could also be designed to allow children (i.e. students) to manipulate things in a 3D virtual world for example “find a heart” and the child could manipulate a 3D body and point to the heart. Such design allows the students to have an entire experience in the 3D virtual world. In some embodiments, the entire classroom is in the metaverse, where avatars of the students can take the class and use the service.

Questions may be of a yes or no, multiple choice, or essay type. Questions may be given a standard time period (for example 30 seconds) for students to answer. In some embodiments, each question has a duration until a certain percentage (for example 80%) of students have answered. In some embodiments, the appropriate duration for a particular question can be determined based on students' previous performance of answering questions. A subset of a large question pool may be automatically selected by a testing server software for presentation to the student. The questions may be selected for randomization to present a unique test to each student. Yes or no and multiple choice questions may be automatically graded by a server software, and, at the discretion of the test administrator, the results may be presented to the student upon completion of the test via dynamic web page or e-mail. Proctored testing can be secured by means of a dual login requirement that verifies the presence of an authorized testing monitor at each student location. In some embodiments, the students are not required to answer the questions. The learning intervention may be a note that allows the students to ponder a relevant topic in the midst of the video. The note can be “Think about objects that run on electricity in your home” or “Google the word catalyst”. A note takes no submission from the student.

In some embodiments, an answer box is provided to allow a student to type a question or comment (such as responses to the learning interventions) directed to the teacher. The present hardware contemplated to be used in the proposed system may allow up to 1024 characters to be included in the answer box. However, the exact number of characters is not crucial to the concept being taught herein. A status line may be used to reflect the time that each question or comment was received. The teacher's monitor can display a notification, for example the student name of the student submitting the question or comment or an indicator next to the student name on the teacher's display, alerting the teacher to the fact that a question or comment has been received. The question or comment can only be seen by the teacher and serves to enhance student response by not embarrassing the student who has a question that might not otherwise be asked in front of a class full of other students. All questions or comments are logged by the software to allow teacher review at a later time, to determine class participation or to compare a “FAQ” for e-mail to the students.

In some embodiments, students can raise questions, whether in response to a query from the teacher or a learning intervention, or on an ad hoc basis during the class. Questions may be raised through an input device (e.g. keyboard) or by raising a virtual hand as is known in the art.

Where, for example, multiple students ask the same or similar question, the teacher may pause the class and deliver a clarification. Alternatively, the system 200 may pause the class—i.e. stop the video-once a threshold number of the same or similar questions has been raised, or a threshold number or proportion of the class has raised such a question. Similarity can be determined using NLP —e.g. through Euclidean distance between input vectors or word vectors as mentioned below. The system 200 may pause the class either when the threshold number or proportion is reached, or at a logical next point—e.g. completion of a sentence or paragraph being delivered in the video. The system 200 may also, or alternatively, analyse the questions using NLP and identify from a transcript of the class a location in the video to which a topic covered in the questions relates—i.e. when that topic was discussed in the video—and cause playback of the topic to repeat. After playback of the topic is concluded, the system 200 may cause the video to continue from that end of the topic, or may cause the video to jump back to where it was when the threshold number or proportion of questions was received.

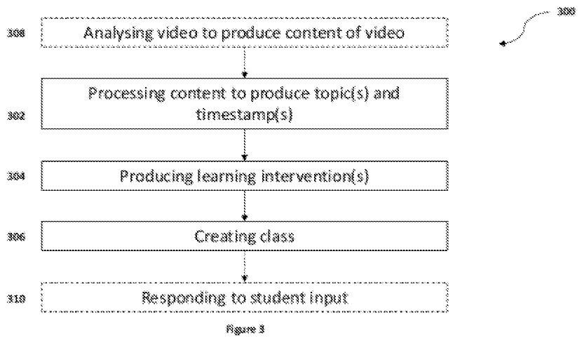

In some embodiments, the system 200 pauses playback and/or causes playback of content relating to the topic in the questions to repeat, but also provides an additional ad hoc learning intervention. The ad hoc learning intervention can be delivered by a teacher or can be generated by the system 200 in the same way as clarification is given in accordance with step 310 of FIG. 3.

Each of the student workstations (which may be the students' laptops or mobile phones, or other devices) would be provided with an input means such as a keyboard as well as a mouse. The keyboard can be provided into two sections. The first section would include a standard typewriter keyboard allowing each student to type in the aforementioned questions or comments directed to the instructor. The second section would include a number of response buttons allowing the student to interact with the instructor in an intuitive, rapid manner. These response buttons or icons could include “yes” or “no” buttons as well as numerical or letter buttons allowing the user to answer “yes” or “no” as well as to respond to multiple choice questions. These response buttons can be configured to allow almost any action such as raised hand, fast, slower or help. These responses are displayed by the student name on the instructor's class monitor as previously discussed. All responses to “yes” or “no” questions as well as multiple choice questions are logged by the software included in the server to allow grading of quiz questions. Formal testing of the student could also be done using this system. In some examples, these buttons or icons can be displayed on the student's monitor.

In the students' workstations, a monitor may be included connected to a processor which in turn is connected to control devices, such as the keyboard and mouse. The monitor can be divided into several sections, although the exact configuration of this monitor is not crucial to the present teachings. For example, one section of the monitor would consist of a live picture of the teacher. A speaker provided directly on the monitor or associated therewith, may be used to hear the teacher's presentation. A camera would also be provided to all the students' workstations allowing video information generated at the student workstation to be displayed on the teacher's monitor. Additionally, a microphone may be also included to allow each student to provide an audio response to be received by the teacher's speaker.

In the present disclosure, the videos and learning interventions may lose synchronization because the bandwidths of different students' devices are different. In order to deal with this, the error can be corrected at the time of displaying the learning interventions, by waiting for a second or two when the quiz or intervention loads or afterwards—e.g. taking a few seconds to display an intervention on a network with low latency, and displaying the same intervention immediately on a network with high latency, such that display of the intervention on the two networks is synchronised. In other words, the delay imposed on display of an intervention, or subsequent video, on a low latency network is equal to the delay experienced on the high latency network.

In general, displaying the learning interventions to the viewers comprises synchronizing the learning interventions for the viewers, based on a network latency for each viewer. Different streaming video compression standards and display area sizes may also be used primarily dependent upon the user's available communication bandwidth, hardware and software configuration. Proprietary streaming systems, such as QuickTime or RealVideo, may further be used in the lower-bandwidth situations, but ISO standards-based systems are preferred. It will be appreciated that transcoding latency is an issue that requires careful attention to synchronize the display video and learning interventions with all of the other virtual class components.

In some embodiments, the videos and learning interventions can be synchronized by delaying display of a learning intervention or delaying ongoing play of video after the display of the learning intervention. The videos and learning interventions may also be synchronized by changing the duration of the intervention, e.g. by displaying a learning intervention for longer or shorter periods to different viewers. In particular, the answers of a learning intervention may be displayed for longer or shorter to achieve synchronization. An opening or closing animation can be shown together with the videos or learning intervention to synchronize the videos displayed on different viewers' devices. It will be appreciated that the synchronization process can also be adjusted depending on the nature of the learning intervention. For example, when the learning intervention is part of a competitive question and answer process, an opening/closing animation could be displayed to perform synchronization rather than providing different response time to different students.

The configuration of the virtual class is designed to facilitate live student space in a low bandwidth environment. Auto sensing software can be implemented to test the user's hardware, software and network conditions and adjust communication speed or data resolution (e.g. high quality video on low latency networks versus comparatively lower quality video on higher latency networks) as required for all portions of the virtual class, and allow improvement of the user's experience. The present system would utilize various types of software among one or a plurality of different servers to allow optimization for specific purposes and to enhance throughput and load balancing. UNIX, LINUX and WINDOWS platforms with standards-based software (customized or off the shelf) are networked and not clustered to provide maximum performance.

The present invention also relates to a system for creating a virtual class based on a plurality of videos, comprising a plurality of processors configured to:
synchronise display of a first video of the plurality of videos to a plurality of viewers;
identify one or more timestamps in the first video;
synchronise display of one or more learning interventions related to the first video to the viewers at each of the one or more timestamps;
collect a response from each viewer to the one or more learning interventions; and
for each viewer, select one or more respective videos from the plurality of videos to display to the viewer based on the response of the viewer.

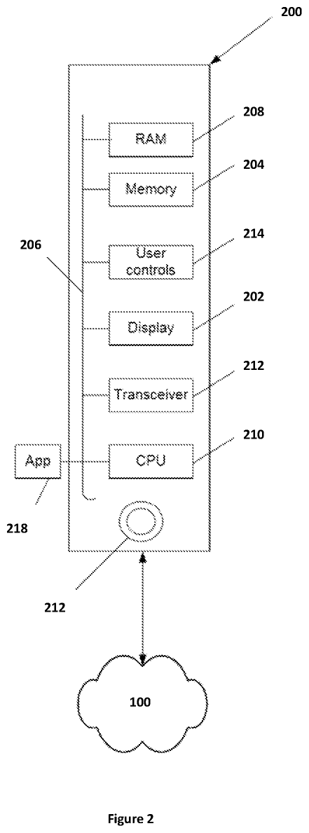

FIG. 2 is a block diagram showing an exemplary computer device 200, in which embodiments of the invention may be practiced, such as methods 100 and 300. The computer device 200 may be a mobile computer device such as a smart phone, a wearable device, a palm-top computer, and multimedia Internet enabled cellular telephones, an on-board computing system or any other computing system, a mobile device such as an iPhone TM manufactured by Apple™, Inc or one manufactured by LG™, HTC™ and Samsung™, for example, or other device.

As shown, the mobile computer device 200 includes the following components in electronic communication via a bus 206:
(a) a display 202;
(b) non-volatile (non-transitory) memory 204;
(c) random access memory (“RAM”) 208;
(d) N processing components 210;
(e) a transceiver component 212 that includes N transceivers; and
(f) user controls 214.

Although the components depicted in FIG. 2 represent physical components, FIG. 2 is not intended to be a hardware diagram. Thus, many of the components depicted in FIG. 2 may be realized by common constructs or distributed among additional physical components. Moreover, it is certainly contemplated that other existing and yet-to-be developed physical components and architectures may be utilized to implement the functional components described with reference to FIG. 2.

The display 202 generally operates to provide a presentation of content to a user, and may be realized by any of a variety of displays (e.g., CRT, LCD, HDMI, micro-projector and OLED displays).

In general, the non-volatile data storage 204 (also referred to as non-volatile memory) functions to store (e.g., persistently store) data and executable code. The system architecture may be implemented in memory 204, or by instructions stored in memory 204.

In some embodiments for example, the non-volatile memory 204 includes bootloader code, modem software, operating system code, file system code, and code to facilitate the implementation components, well known to those of ordinary skill in the art, which are not depicted nor described for simplicity.

In many implementations, the non-volatile memory 204 is realized by flash memory (e.g., NAND or ONENAND memory), but it is certainly contemplated that other memory types may be utilized as well. Although it may be possible to execute the code from the non-volatile memory 204, the executable code in the non-volatile memory 204 is typically loaded into RAM 208 and executed by one or more of the N processing components 210.

The N processing components 210 in connection with RAM 208 generally operate to execute the instructions stored in non-volatile memory 204. As one of ordinarily skill in the art will appreciate, the N processing components 210 may include a video processor, modem processor, DSP, graphics processing unit (GPU), and other processing components.

The transceiver component 212 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The system 200 of FIG. 2 may be connected to any appliance 418, such as one or more webcams, a microphone, a keyboard for responding to interventions, raising hands and other student actions and other systems.

It should be recognized that FIG. 2 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 204. Non-transitory computer-readable medium 204 includes both computer storage medium and communication medium including any medium that facilitates transfer of a computer program from one place to another. A storage medium may be any available medium that can be accessed by a computer.

FIG. 3 shows a method 300 that may be similarly performed by system 200. The method 300 is for creating a virtual class and comprises (step 302) processing content of a video to identify one or more topics covered by the content and a timestamp corresponding to each said topic, (step 304) producing learning interventions, and (step 306) creating the class.

Step 302 involves processing content of a video to identify a topic or topics covered by the content and a timestamp corresponding to each said topic. This processing step can be performed in a way that best suits the video content. For example, where the video content is delivered by a narrator or presenter, processing the content of the video can include processing a transcript of the video using a natural language processing (NLP) algorithm. The NLP algorithm then identifies the topic or topics covered by the video based on the words in the transcript.

In some instances, a transcript of the video will be unavailable. In such instances, a content generation step (step 308) may be performed. The content generation step can involve analysing the video using a machine learning model to produce the content of the video—e.g. the transcript of the video. The machine learning model may be a speech-to-text conversion model for converting, for example, narration or speech in the video into text. In other embodiments, the machine learning model is an image recognition model for identifying text in the video, for analysing the mouth movements of a presenter to identify words spoken by the presenter (this may be cross-referenced against the output of a speech-to-text recognition model, to improve the confidence of the accuracy of the transcript) or for extracting other visual information from the video for incorporation into the transcript.

With further reference to step 302, timestamps are also identified for each topic. A timestamp may be the time point (i.e. point in a video) at which teaching on a particular topic concludes. Notably, the teaching may conclude before the last mention of the topic in a video. For example, teaching of probability theory in a machine learning video may conclude at a particular time point, even though the video may later make a statement that “The output of the classification model will be known to a degree of confidence determined according to the previously taught principles of probability theory.” The appropriate position in the video for embedding a learning intervention relating to a topic, may be the time point of conclusion of teaching of a topic rather than the last mention of that topic. To clarify: NLP can determine when a topic is the main point of a portion of the video (i.e. when the subject is being taught) and when passing reference is made to it during another portion of the video (i.e. when the topic is not being taught). The location at which the subject is no longer being taught can be the time point for that topic, the time point being used as the timestamp for embedding a learning intervention.

At step 304, each topic is analysed to produce a learning intervention corresponding to the topic. Analysing a topic can involve using a NLP algorithm to identify relevant keywords or other indicators in the teaching of a topic, and formulating a question to test the teaching in a manner known to the skilled person.

At step 306, the class is created by embedding each learning intervention at the corresponding timestamp in the video. The class is a video configured such that the video is played back to a user up to a first of the timestamps. The video is then paused for display of the embedded learning intervention corresponding to the first timestamp. The class may therefore be configured to be run according to method 100.

Rather than generating a transcript from a previously created video, step 308 may involve receiving class content from which to generate the video, and then processing the class content to generate the video. To that end, the class content may be a complete transcript of the content of the video—i.e. the class content may be the same as the content for the video. The class content may alternatively be a course or class syllabus or summary. The syllabus or summary may be expanded upon to produce the content for the video, using NLP in a known manner, or by identifying online discussion or content for individual points (e.g. topics) covered by the syllabus or summary (individual points may be identified using NLP or other mechanism).

Step 308 can further include generating a synthetic video. The synthetic video may be a video in which an avatar is generated to appear to speak words in the class content, or content of the video corresponding to the class content. The synthetic video may instead be a video with narration produced according to the content generated from the class content. Thus, step 308 can involve processing the class content (which can include generating content for the video based on the class content) using a synthetic video generation model to generate a synthetic video corresponding to the class content.

After a day's content has been delivered, or at some other juncture where a significant amount of content has been delivered or a logical end point of a class has been reached, a student may have some clarifying questions. It can be useful to deal with these questions at the end of teaching, to ensure the class content is fresh in the mind of the student when they receive the requested clarification.

To that end, step 310 involves responding to user or student input. To respond to user input, the system 200 can receive—e.g. from a user input device such as a keyboard, microphone or other input device—a student input. The student input comprises a query or question, seeking information or clarification about the content of the video (i.e. content of the class). The student input is then processed, e.g. by a NLP model, to extract or otherwise identify the query. In this context, the “query” is a search string, word vector, set of word vectors or similar, that can be used by a machine learning algorithm to identify content in a database, online or elsewhere, to respond to the query. The machine learning algorithm is referred to as a “response model” since it locates content responsive to the query. The response model then generates the response to the query and it is then presented to the user—e.g. queues a video from YouTube, located using the query, and displays it to the user, or generates a text response that is then converted to speech and presented to the user, or any other response delivery method.

The student input can be given in various ways—e.g. verbally through a microphone, or as text input via a keyboard. In the case of a verbal input, identifying the query can involve applying a speech-to-text model to the verbal input. Similarly, where the input is a text input, or once the text has been produced by the speech-to-text model, a NLP model may be applied to the text or text input to identify the query.

Notably, method 300 involves creating a class, producing learning interventions at and embedding them according to timestamps in a video. That video can be presented to a user, or plurality of users, in accordance with the method 100. On completion of presentation according to method 100, inputs can be acquired and responded to according to step 310. Since user inputs may not be gathered in all cases, and since presenting the class per method 100 may be performed after step 308, step 310 is optional and thus shown in broken lines. Similarly, where a video is pre-prepared, step 308 need not be performed and is thus shown as optional, in broken lines.

In addition, the methods 100, 300 may involve monitoring progress of each individual student. In response to the individual student spending a predetermined amount of time in classes displayed to the student in accordance with methods 100,300, the student may receive a predetermined reward—e.g. screen time, virtual currency to use on other platforms and other rewards such as e-commerce goods. The methods 100, 300 may involve switching from a restricted access mode to an unrestricted access mode based on the reward. For example, a student may earn a predetermined amount of time in unrestricted access based on their performance during a class or classes—e.g. at or above a predetermined accuracy in answering learning interventions (e.g. 80%) or a predetermined amount of time in classes (e.g. two hours). Restricted access mode may permit access to a proper subset of applications when compared with unrestricted access mode. E.g. restricted access mode may only permit access to academic content sources whereas unrestricted access mode may permit access to those sources in addition to other sources such as entertainment sites including YouTube.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of creating an interactive class, comprising:
processing content of a class to identify one or more topics covered by the content and a timestamp corresponding to each said topic;
processing each topic to produce a learning intervention corresponding to the topic; and
creating the interactive class by embedding each learning intervention at the corresponding timestamp in the class, the interactive class being configured such that on a user progressing through the interactive class to a first said timestamp the interactive class is paused for display of the learning intervention corresponding to the first timestamp.

2. The method of claim 1, wherein processing content of a class to identify one or more topics covered by the content and a timestamp corresponding to each said topic, comprises processing a transcript of the class using a natural language processing (NLP) algorithm to identify the one or more topics.

3. The method of claim 1, further comprising analysing the class using at least one machine learning model to produce the content of the class, the content comprising a transcript of the class.

4. (canceled)

5. (canceled)

6. The method of claim 1, wherein processing content of a class to identify one or more topics covered by the content and a timestamp corresponding to each said topic, comprises determining a time point at which teaching of each topic concludes, the timestamp for each respective topic being the time point at which teaching of each topic concludes.

7. The method of claim 1, further comprising receiving class content and processing the class content to generate the interactive class.

8. (canceled)

9. The method of claim 7, wherein processing the class content comprises using a synthetic video generation model to generate a synthetic video corresponding to the class content.

10. The method of claim 9, wherein processing the class content comprises using a NLP model to produce the content based on the class content, and using the synthetic video generation model to generate the synthetic video based on the content.

11. The method of claim 9, wherein the synthetic video comprises an avatar reading the content.

12. The method of claim 1, further comprising:
receiving a student input from the user;
processing the student input to identify a query; and
generating a response to the query using a response model.

13. The method of claim 12, wherein processing the student input to identify a query comprises one of a speech-to-text model to a verbal input from the user, and applying a NLP model to a text input from the user, to identify a query corresponding to the verbal input or text input.

14. (canceled)

15. The method of claim 12, wherein generating a response to the query using a response model comprises at least one of identifying a video corresponding to the query and displaying the video to the user, and generating a text or audio response to the query and outputting the text or audio response to the user.

16. The method of claim 1, wherein the interactive class is a first video of a plurality of videos and the user is one of a plurality of viewers, the method comprising:
synchronising display of the first video to the plurality of viewers;
identifying each timestamp in the first video;
synchronizing display of each learning intervention to the viewers at each timestamp;
collecting a response from each viewer to each learning intervention; and
for each viewer, selecting one or more respective videos from the plurality of videos to display to the viewer based on the response of the viewer.

17. A system for creating an interactive class, comprising a memory and at least one processor configured to:
process content of a class to identify one or more topics covered by the content and a timestamp corresponding to each said topic;
process each topic to produce a learning intervention corresponding to the topic; and
create the interactive class by embedding each learning intervention at the corresponding timestamp in the class, the interactive class being configured such that on a user progressing through the interactive class to a first said timestamp the interactive class is paused for display of the learning intervention corresponding to the first timestamp.

18. The system of claim 17, wherein the at least one processor is configured to analyse the class using at least one machine learning model to produce the content of the class, the content comprising a transcript of the class, the processing being configured to process the content of the class to identify one or more topics covered by the content and a timestamp corresponding to each said topic, by processing the transcript of the class using a natural language processing (NLP) algorithm to identify the one or more topics.

19. The system of claim 17, wherein the at least one processor is configured to receive class content and process the class content to generate a video.

20. The system of claim 17, wherein the at least one processor is configured to:
receive a student input from the user;
process the student input to identify a query; and
generate a response to the query using a response model.

21. The system of claim 17, wherein the interactive class is a first video of a plurality of videos and the user is one of a plurality of viewers, the at least one processor being configured to:
synchronise display of the first video to the plurality of viewers;
identify each timestamp in the first video;
synchronize display of each learning intervention to the viewers at each timestamp;
collect a response from each viewer to each learning intervention; and
for each viewer, select one or more respective videos from the plurality of videos to display to the viewer based on the response of the viewer.

22-35. (canceled)

36. A system of creating a virtual class based on a plurality of videos, comprising a memory and a plurality of processors configured to:
synchronise display of a first video of the plurality of videos to a plurality of viewers;
identify one or more timestamps in the first video;
synchronise display of one or more learning interventions related to the first video to the viewers at each of the one or more timestamps;
collect a response from each viewer to the one or more learning interventions; and
for each viewer, select one or more respective videos from the plurality of videos to display to the viewer based on the response of the viewer.

37. The system of claim 36, wherein the plurality of processors are configured to capture the first video from an original video according to the content of the learning interventions.

38-43. (canceled)

44. The system of claim 36, wherein the plurality of processors are configured to stream the viewers to a plurality of groups based on the response and/or behaviour of each viewer.

45-49. (canceled)
